(19) United States
(12) Patent Application Publication
(10) Pub. No.: US 2012/0258236 A1
(43) Pub. Date: Oct. 11, 2012

(54) COMPOSITION WITH HIGH PROTEIN CONTENT FOR THE FOOD INDUSTRY

(75) Inventors: Adriana Fernanda Cruz Serna, Bogota (CO); Nelson Veintemilla Granados, Bogota (CO)

(73) Assignee: Team Foods Colobia S.A., Bogota (CO)

(21) Appl. No.: 13/393,655

(22) PCT Filed: Sep. 2, 2009
(86) PCT No.: PCT/IB09/06718

§ 371 Date: Jun. 19, 2012

(51) Int. Cl. A23J 1/00; A23L 1/305; A23J 1/14; A23J 1/06; A23J 1/09

(52) U.S. Cl. 426/657

(57) ABSTRACT

The invention relates to a novel protein composition comprising sources of both animal and vegetable origin, having a high PDCAAS nutritional quality value and containing essential amino acids better than those of the proteins in a whole egg, as well as essential amino acids similar to or better than those in meat, suitable for use in pastries, extruded snacks, pastries and meat products.

### FIELD OF THE INVENTION

The present invention relates to a new protein composition comprising ingredients of both animal and vegetable origin, with a high content of protein and having a high PDCAAS nutritional quality value and a greater contribution of essential amino acids higher than those of the proteins in a whole egg, whole milk and bovine meat.

### BACKGROUND OF THE INVENTION

Proteins are the main component of the human body because the body uses it to form new cells, enzymes, neurotransmitters and the formation of DNA/RNA and to build and maintain tissues.

Proteins consist of amino acids, which are generally classified into essential amino acids, and nonessential.

By “essential amino acid” refers to those that the human body is not able to synthesize by itself, and have to be taken externally by a diet containing them.

Essential amino acids in humans comprising phenylalanine, isoleucine, leucine, lysine, methionine, threonine, tryptophan, valine and histidine.

Previously, the PER rating was used to assess the quality of the proteins (Protein Efficiency Ratio) relative to the protein efficiency rate. This classification is based on the amino acid requirements of young growing rats so that later the United Nations Food and Agriculture Organization (FAO) and World Health Organization (WHO) decided to change the method for evaluating the protein quality by Protein Digestibility Corrected Amino Acid Score and was approved by the FDA for protein evaluation.

This method is based on generating a score comparing these amino acids with a pattern of amino acid requirements established by FAO/WHO for children between two and five years of age.

Limiting the essential amino acid within product amino acids to evaluate is used to establish the not corrected amino acid score which is subsequently multiplied by the digestibility of feed to get PDCAAS score. The foods that have a PDCAAS score equal to or greater than the established amino acid requirements after correction by digestibility receive a maximum value of 1.0.

From the state of the art is known to use soy products such as soy isolates (with protein percentages greater than 90%) with a PDCAAS score of 1, however, when considering the nutritional value in terms of essential amino acid composition, is found that said derived products solely from soybeans, do not have the same values of the essential amino acids present in the product of the invention that are closer to the proteins of meat, egg and milk.

In the prior art compositions we found mixtures or protein compositions as described in the international patent application WO 2007/063142, which relates to a mixture of proteins based on caseinatos, peas and milk whey which are used in the preparation of food products intended for oral or enteral feed.

This reference uses as a source of animal origin, proteins from milk and vegetable source proteins from peas. By contrast, the present invention used as a source of animal origin, dried blood plasma and powdered egg albumin and soy flour as a vegetable source. This product is designed to cover treatment issues in patients with nutritional deficiencies in the present invention the product is designed to be used as raw material in food preparations of standard diet that may have an additional enrichment of its protein content.

The U.S. Pat. No. 4,158,069 publication to Cox refers to a protein-enriched dough by adding a milk protein fraction (whey and caseinate), an exogenous addition of lysine and an addition of a protein source from fish, peanuts, cotton, or soy containing a total protein percentage from 20 to 25%. The product of this invention is focused only to the pastes enrichment and further does not specifically provides the essential amino acids content as nutritional value or PDCAAS/PER scores. The raw materials of animal origin used are different than by those utilized in this invention.

The U.S. Pat. No. 5,242,697 publication to Luca refers to a method for the preparation of certain food products which contain protein, carbohydrate, addition of vitamins, minerals and polyunsaturated vegetable oils in which a content of essential amino acids are added to food in a ratio determined according to the type of food and the type of individuals and target therapeutic treatment. Foods to be fortified include bovine milk, milk powder, wheat flour, soy products, rice, corn, amaranth, oats, potatoes, legumes (beans, peas, lentils and the like) and mixtures thereof, and milk from ruminants (sheep, goat and ox). The fortified specific products of this invention which contain the essential amino acids and carbohydrates and additionally polyunsaturated fats, has a particular use in the treatment or prevention of malnutrition caused by lack of protein and calories mainly in patients with cancer, AIDS, burns, surgery and kidney disease, liver disorders, diabetes and the like as well as women who are pregnant. These products can be administered orally either in normal food or in powder, capsule, tablet or liquid solutions. Unlike of this reference is directed particularly to therapeutic treatments, the present invention relates to a high-protein product that can be used as feedstock for the production of foods enriched in a normal diet. The claimed invention relates to a higher value of net nitrogen utilization NNU but nor includes the assessment of the proteins quality neither the PER and PDCAAS methods.

### BRIEF SUMMARY OF THE INVENTION

The present invention relates to a new protein composition comprising both animal and vegetable origin sources which have high nutritional quality value PDCAAS and a supply of essential amino acids higher than of whole egg protein, whole milk and bovine meat origin.

Dried bovine plasma and egg albumen powder was found as an animal origin source, soybean flour, and/or soy concentrate and/or isolated soybean was found as a vegetable origin source and/or mixtures thereof.

This composition has a high nutritional value given by the amino acid PDCAAS score which is calculated according to the content of limiting amino acid lysine multiplied by the average digestibility of protein sources to obtain a PDCAAS score from 0.89 to 0.96 for the composition of the invention.

### DETAILED DESCRIPTION OF THE INVENTION

The object of this invention is to provide a new protein composition which has a high nutritional value compared to whole eggs, whole milk and bovine meat.

Another object of the present invention is to employ said composition as an ingredient in the food industry mainly for nutritional enrichment in bakery products, snacks, pastes and meat.

Essential amino acids of eggs, milk and bovine meat was taken as base like a reference in order to obtain a new protein composition to present values very near or better than those of these protein sources. The essential amino acids of meat (70% lean, 30% fat), whole eggs and whole milk was taken as reference and are shown in Table 1.

TABLE NO. 1
Amino acid contents present in bovine
lean meat, whole egg and whole milk.

| | Lean meat | Whole egg | whole milk |
|---|---|---|---|
| | sample | sample | sample |
| AMINO ACID | mg/100 g | mg/100 g | mg/100 gr |
| Tryptophan | 206 | 167 | 75 |
| Threonine | 804 | 556 | 143 |
| Isoleucine | 828 | 672 | 165 |
| Leucine | 1456 | 1088 | 265 |
| Lysine | 1532 | 914 | 140 |
| Methionine | 471 | 380 | 75 |
| Cystine | 206 | 272 | 17 |
| Fenilalanine | 719 | 681 | 147 |
| Tirosine | 619 | 500 | 152 |
| Valine | 896 | 859 | 192 |
| Arginina | 1164 | 821 | 75 |
| Histidina | 631 | 309 | 75 |
| Alanine | 1111 | 736 | 103 |
| Aspartic acid | 1682 | 1330 | 237 |
| Glutamic acid | 2767 | 1676 | 648 |
| Glycine | 1005 | 432 | 75 |
| Proline | 813 | 513 | 342 |
| Serine | 704 | 973 | 107 |
| Total protein, gr | 18.4 | 12.6 | 3.2 |

* Source: Nutrition Data

The inventors of the present invention found that it was necessary to use both protein sources of animal origin as sources of vegetable origin to fulfill with nutritional balance suitable of essential amino acids for the purpose of the invention and which had a high protein quality score PDCAAS corrected by digestibility, where animal proteins play an important role finding an important nutritional balance between proteins derived from soy, egg albumin and dried bovine plasma mainly.

Taking into account the reference values in Table 1 showed that the suitable composition for having higher value of essential amino acids than the whole eggs, whole milk and bovine meat comprises a mixture of soybean flour and/or soy isolated from 30% to 70% by weight, bovine plasma from 20% to 50% by weight and egg albumin from 8% to 25% by weight.

In a preferred embodiment of the invention the composition comprises 45-55 wt % soy flour and/or soy isolate, 25-35% of bovine plasma and 12 to 22% egg albumin.

The protein composition is characterized by having a total protein content between 45%-85%, preferably between 50%-75% and more preferably between 60%-70% with a range of amino acids expressed in Table 2.

TABLE 2
Amino acid content of protein mixture of the invention

| | Results of protein |
|---|---|
| | sample of invention |
| Amino acid | mg/100 gr |
| Tryptophan | 800-1300 |
| Threonine | 3600-4200 |
| Isoleucine | 2700-3300 |
| Leucine | 6000-6800 |
| Lysine | 4800-5500 |
| Methionine | 1100-1600 |
| Cystine | 1300-2000 |
| Fenilalanine | 3600-4200 |
| Tirosine | 2700-3300 |
| Valine | 4400-5000 |
| Arginina | 4400-5000 |
| Histidina | 1700-2300 |
| Alanine | 3300-3900 |
| Aspartic acid | 7500-8300 |
| Ac. Glutamfco | 10600-11500 |
| Glycine | 2400-3100 |
| Proline | 3200-3800 |
| Serine | 4400-5000 |
| Protein total, gr | 60-70 |

* Source, Eurofins USA laboratory analysis

Additionally, the quality score of PDCAAS protein was examined for the product of the invention based on the needs of protein (mg/g) in children over 1 year and adults with which to calculate this score, these reference values are shown in Table 3.

TABLE 3
Amino Acid Requirements for PDCAAS score Amino acid pattern
proposed for children > to 1 year and adults. Institute
of Medicine. National Academy of Sciences. 2002

| AA | (mg/g protein) |
|---|---|
| Histidine | 18 |
| Isoleucine | 25 |
| Leucine | 55 |
| Lysine | 51 |
| Metionine + Cisteine | 25 |
| Phenylalanine + Tyrosine | 47 |
| Treonine | 27 |
| Triptophane | 7 |
| Valine | 32 |

Source: FAO/WHO: Protein Quality Evaluation Report of the Joint
FAO/WHO: Expert Consultation 1989.

A digestibility value of protein composition of the invention was found from 0.8 to 0.98 that based on the limiting amino acid content which according to the Table 3 requirements for the present invention is lysine. PDCAAS score values were obtained from 0.8 to 1.0, preferably from 0.85 to 0.98 and more preferably from 0.89 to 0.96.

It was found that the nutritional composition of the present invention in its content of essential amino acids has values regarding bovine meat protein exceeding 100% thereof, and above 100% in the case of the essential amino acids content in whole milk and whole egg.

It has been found that the product of the invention is very suitable as a raw material of high-protein content for the production of foodstuffs such as pastes, pastries, snacks and extruded products of meat industry such as sausages and beef hamburger.

### EXAMPLE 1

A protein mixture of soybean flour, albumin and plasma was taken

He took a mixture of (Premix protein), according to the following composition

Protein Premix

Soybean flour—50%

Albumin—18%

Plasma—32%

Pastes application tests were performed subsequently according to the following formulas,

Formula 1

High-protein Wheat semolina (14%) 70%—210 g

Protein Premix of the invention 30%—90 g

Water 60%—180 gr

Formula 2

Semolate (semolina protein content (10%) 70%—210 gr

Protein Premix 30%—90 g

Water 60%—180 g

Ingredients were mixed starting by solids and then slowly adding water until complete homogenization. At the end were added 26 g more water to reach desired consistency.

The pastes were left to stand for 20-30 minutes at room temperature, after stretching was allowed to stand for 10 minutes before giving it final stretch and cut. Afterwards the pastes were subjected to a drying process at room temperature for 12 hours.

A sample was taken from pastes made for amino acid analysis to compare with the values in bovine meat. The results are shown in Table 4.

TABLE 4
Amino acid content in protein mixture application
in pastes versus bovine meat.

| | Results | Results | Lean meat |
|---|---|---|---|
| | mg/100 gr | mg/100 gr of | sample |
| AMINO ACIDS | Formula 1 | Formula 2 | mg/100 |
| Tryptophan | 370 | 250 | 206 |
| Threonine | 1150 | 1130 | 804 |
| Isoleucine | 1210 | 1220 | 828 |
| Leucine | 2320 | 2270 | 1456 |
| Lysine | 1480 | 1460 | 1532 |
| Methionine | 570 | 550 | 471 |
| Cystine | 560 | 560 | 206 |
| Fenilalanine | 1500 | 1460 | 719 |
| Tirosine | 840 | 740 | 619 |
| Valine | 1600 | 1590 | 896 |
| Arginina | 1570 | 1510 | 1164 |
| Histidina | 740 | 710 | 631 |
| Alanine | 1230 | 1220 | 1111 |
| Aspartic acid | 2470 | 2440 | 1682 |
| Glutamic Acid | 6300 | 6150 | 2767 |
| Glycine | 1050 | 1100 | 1005 |
| Proline | 2080 | 2060 | 813 |
| Serine | 1470 | 1410 | 704 |
| Total protein, gr | 24.48 | 23.97 | 18.4 |

Source: Formula 1 and 2 pastes analysis Eurofins, Bovine Meat Nutrition Data

Surprisingly it was found that the protein mixture of the invention has very great nutrient advantages since 100 grams of pasta added with this mixture has amino acids values higher than consume 100 g of bovine meat with the exception of lysine amino acid in which the value is not exceeds 100% of the meat value but reaches a value greater than 95% of the content which is equally high and has a high nutritional value. Similarly the results of these pastes compared with the value present in Table 1 for 100 g of whole eggs and whole milk far exceed the essential amino acids supply present therein.

Likewise as to the total protein content of these pastes a contribution value was found much higher of about 24% versus 18% in bovine meat, 12.6% of whole egg and 3.2% of whole milk. (cf Table 4 and Table 1).

PDCAAS score was calculated for protein composition of the example obtaining a value of 0.925 based on the lysine limiting amino acid with a weighted digestibility value between ingredients (soybean flour, bovine plasma, albumin) which for the example composition was 0.92.

As for texture, taste and smell characteristics of the made products against a standard pastes was found acceptance in these products without presenting a score that could markedly away from the standard product. The results are shown in the following table 5.

TABLE 5
Sensorial perception of product manufactured
and prepared for consumption.

| | Formula 1 | Formula 2 | Standard |
|---|---|---|---|
| Characteristic | paste | paste | paste Pattern |
| Color | +++ | +++ | ++++ |
| Odor | ++++ | ++++ | ++++ |
| Sour | +++ | +++ | ++++ |
| Texture | ++++ | ++++ | +++ |
| (hardness) | | | |

It will be apparent to one skilled in the art that various substitutions and modifications may be made to the invention described herein without departing from the scope and spirit of the invention. The invention described herein can be implemented properly in the absence of any element or elements, limitation or limitations not specifically described here. The terms and expressions which have been employed are used as terms and expressions of description and not intended to limit in any way the invention, but it is recognized that various modifications are possible within the scope of the invention. Thus, it should be understood that although the present invention has been illustrated by specific embodiments and optional features, modifications and variations of the concepts described herein can be made by a person skilled in the art. Such modifications and variations are considered within the scope of this invention.

1-8. (canceled)

9. A high-protein food composition comprising animal sources and vegetable sources, wherein the animal sources are selected from the group consisting of dried bovine plasma and egg albumen powder, and wherein the vegetable sources are selected from the group consisting of soy flour, soy concentrate, isolated soybean and a combination thereof.

10. The high-protein food composition of claim 9, comprising a mixture of soybean flour from 30% to 70% by weight, bovine plasma from 20% to 50% by weight and egg albumin from 8% to 25% by weight.

11. The high-protein food composition of claim 9, comprising a mixture of soybean flour from 45% to 55% by weight, bovine plasma from 25% to 35% by weight and egg albumin from 12% to 22% by weight.

12. The high-protein food composition of claim 9, which has a Protein Digestibility Corrected Amino Acid Score PDCAAS from 0.8 to 1.0.

13. The high-protein food composition of claim 9, which has a Protein Digestibility Corrected Amino Acid Score PDCAAS from 0.85 to 0.98.

14. The high-protein food composition of claim 9, which has a Protein Digestibility Corrected Amino Acid Score PDCAAS from 0.89 and 0.96.

15. The high-protein food composition of claim 12, having a higher value of essential amino acids than that of whole eggs and whole milk.

16. The high-protein food composition of claim 13, having a higher value of essential amino acids than that of whole eggs and whole milk.

17. The high-protein food composition of claim 14, having a higher value of essential amino acids than that of whole eggs and whole milk.

18. The high-protein food composition of claim 12, wherein an essential amino acids content has values of bovine meat protein upper to 100%.

19. The high-protein food composition of claim 13, wherein an essential amino acids content has values of bovine meat protein upper to 100%.

20. The high-protein food composition of claim 14, wherein an essential amino acids content has values of bovine meat protein upper to 100%.

21. The high-protein food composition of claim 10, wherein a total protein content is from 45% to 85%.

22. The high-protein food composition of claim 10, wherein a total protein content is from 50% to 75%.

23. The high-protein food composition of claim 10, wherein a total protein content is from 60% to 70%.

24. The high-protein food composition of claim 11, wherein a total protein content is from 45% to 85%.

25. The high-protein food composition of claim 11, wherein a total protein content is from 50% to 75%.

26. The high-protein food composition of claim 11, wherein a total protein content is from 60% to 70%.

27. The high-protein food composition of claim 9 comprising a range of essential amino acids in mg per 100 g of product between the following values:

| | |
|---|---|
| Tryptophan | 800-1300 |
| Threonine | 3600-4200 |
| Isoleucine | 2700-3300 |
| Leucine | 6000-6800 |
| Lysine | 4800-5500 |
| Methionine | 1100-1600 |
| Cystine | 1300-2000 |
| Phenylalanine | 3600-4200 |
| Tyrosine | 2700-3300 |
| Valine | 4400-5000 |
| Histidine | 1700-2300 |

28. The high-protein food composition of claim 9, which can be utilized in applications of pasta like extruded snacks applications, pastries and meat products.
